(19) United States
(12) Patent Application Publication
(10) Pub. No.: US 2025/0298743 A1
(43) Pub. Date: Sep. 25, 2025

(54) ADVANCED FILE SYSTEM WITH DYNAMIC BLOCK ALLOCATION

(71) Applicant: Micron Technology, Inc., Boise, ID (US)

(72) Inventors: Dengfeng Ruan, Shanghai (CN); Peng Fei, Shanghai (CN)

(21) Appl. No.: 19/067,399

(22) Filed: Feb. 28, 2025

Related U.S. Application Data
(60) Provisional application No. 63/567,726, filed on Mar. 20, 2024.

(51) Int. Cl. G06F 12/02

(52) U.S. Cl. CPC G06F 12/0246; G06F 2212/7202

(57) ABSTRACT

Systems, methods, and computer readable media for moving data blocks from a user area to a file system area. The method includes receiving a command from a host system and determining a number of free data blocks in a file system area of a memory device. The method further includes determining that the number of free data blocks in the file system area does not satisfy a threshold criterion, and allocating one or more data blocks from a user data area to the file system area.

### RELATED APPLICATIONS

This application claims the benefit of U.S. Provisional Patent Application No. 63/567,726, filed Mar. 20, 2024, the entire contents of which are hereby incorporated by reference herein.

### TECHNICAL FIELD

Embodiments of the disclosure relate generally to memory sub-systems, and more specifically, relate to an advanced file system with dynamic block allocation in a memory sub-system.

### BACKGROUND

A memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2A illustrates a logical unit (LUN) level view of an example method for dynamic block allocation in accordance with some embodiments of the present disclosure.

FIG. 2B illustrates a logical unit (LUN) level view of an example method for dynamic block allocation in accordance with some embodiments of the present disclosure.

FIG. 3 is a flow diagram of an example method for dynamic block allocation in a file system area in accordance with some embodiments of the present disclosure.

FIG. 4 is a flow diagram of an example method for dynamic block allocation in a file system area in accordance with some embodiments of the present disclosure.

FIG. 5 is a block diagram of an example computer system in which embodiments of the present disclosure can operate.

### DETAILED DESCRIPTION

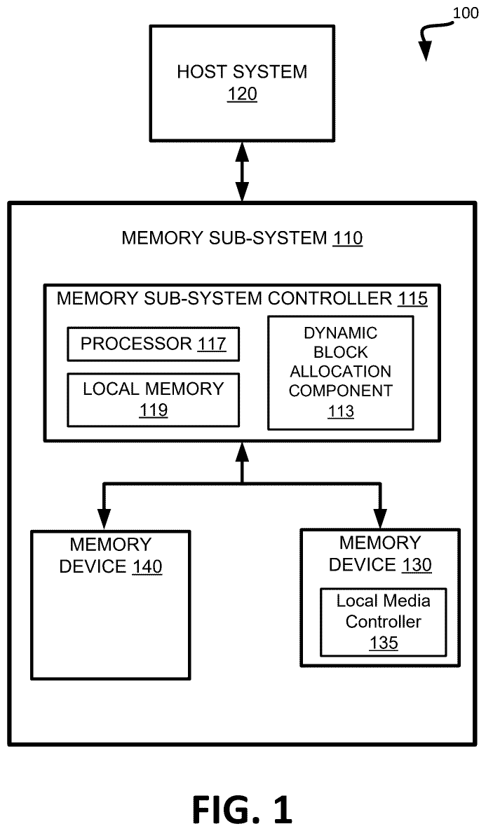

Aspects of the present disclosure are directed to methods and systems for dynamically allocating data blocks from a user area of a memory device to a file system area (FSA) of the memory device, during runtime in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. A non-volatile memory device is a package of one or more dies. Each die can include one or more planes. For some types of non-volatile memory devices (e.g., negative-and (NAND) devices), each plane includes a set of physical blocks. Each block includes a set of pages. Each page includes a set of memory cells, which store bits of data. For some memory devices, such as NAND devices, blocks are the smallest area than can be erased and pages within the blocks cannot be erased individually. For such devices, erase operations are performed one block at a time.

The host system can send access requests (e.g., write commands, read commands) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), etc.

“System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

A file system area (FSA) in a memory device refers to a section of the device where the file system files (e.g., firmware image, log data, firmware parameters, etc.) are stored and managed. The file system is a data structure that an operating system uses to control how data is stored and retrieved on the memory device. The file system area includes data structures that the file system uses to organize and manage files. The data structures include a master file table (MFT) or equivalent, which is a database including information about files and directory on the device. The data structures further include a file allocation table (FAT) or equivalent, which keeps track of which areas of the device are free and which are occupied. The data structures further include directories and metadata relating to files, including information about where files are located on the device, their size, creation/modification dates, and other attributes. The data structures may also include a boot sector which may include information for booting the operating system and also include details about the file system itself.

In conventional approaches, a fixed number of data blocks are pre-allocated for the file system during the memory device manufacturing process, and the allocation does not change over the life cycle of the memory device. However, when blocks in the file system area encounter one or more defects such as high uncorrectable bit error rate (UBER), program failure, erase failure, die failure, etc., the number of bad blocks may exceed a defined threshold, and the FSA may go into a read only mode not allowing any host system writes, thereby impacting the functionality of the memory device.

Aspects of the present disclosure address the above and other deficiencies by providing an efficient method for dynamically allocating blocks from a user area of the memory device to a file system area of the memory device when the number of bad blocks in the file system area exceed a defined threshold, or when the number of good blocks in the file system area fall below a defined threshold. The block allocation is performed dynamically during runtime, thereby avoiding any impact to the functionality of the memory device. Embodiments also provide an efficient method for selecting suitable blocks for allocating to the file system area of the memory device without compromising the integrity of host data. Embodiments also provide an efficient method for managing bad blocks in the file system area of the memory device so that the memory device does not enter read only mode when suffering from one or more defects.

Advantages of the disclosed embodiments include but are not limited to improved performance in the memory sub-system. For example, there is no impact to data integrity of the host data and drive functionality when dynamic allocation is implemented. Additionally, there is no impact to drive performance or drive endurance. With the disclosed methods, entering read-only mode can be avoided for longer periods of time, thereby increasing the lifespan of the memory device. Additionally, with the disclosed methods of dynamic block allocation, FSA can be functional even when SSD suffers, for example, catastrophic NAND defects (e.g., multiple die failures). Furthermore, the disclosed embodiments strengthen the drive reliability and extend drive life cycle. They also reduce the possibility of data loss and field remote memory access (RMA) risk without any added extra hardware costs.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM), synchronous dynamic random access memory (SDRAM), a ferroelectric random access memory (FeRAM), a magnetic random access memory (MRAM), and a resistive random access memory (RRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit (LUN) of the memory device used to store data. With some types of memory (e.g., NAND), pages can be grouped to form blocks. Some types of memory, such as 3D cross-point, can group pages across dice and channels to form management units (MUs).

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. For instance, the memory sub-system controller 115 can include a cache 101 and a cache controller 103. For example, cache 101 can be SRAM. Memory sub-system can be configured such that memory device 130 and/or 140 can be memory mapped storage for the memory sub-system 110. Memory sub-system 110 can be configured to include cache memory for caching data stored in the memory mapped stored of the memory sub-system 110. Memory device 130, memory device 140, and/or cache 101 can be configured as cache memory for the memory sub-system 110. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130. The memory device (e.g., DRAM or FeRAM device) may include multiple memory banks, which are grouped in bank groups. Each memory bank is a memory array that includes a plurality of memory cells, such that each memory cell is capable of storing, depending on the memory cell type, one or more bits of information.

As noted herein above, the memory device 130 may further include a set of row buffers, which may be utilized for storing the data retrieved from a row of a bank. The memory device may further include an on-die cache, which may be utilized for caching portions of the data stored in the main memory banks. In an illustrative example, the data that has been read from a memory bank into a row buffer may be also cached by the on-die cache, which thus may be utilized for servicing subsequent memory access requests that are directed to the same row. In some implementations, the cache line size of the on-die cache may match the row buffer size, thus simplifying the cache line allocation schemes that may be employed for managing the cache.

Various other components, such as sense amplifiers, input/output interfaces, and command interfaces are omitted from FIG. 1 for clarity and conciseness. In one embodiment, the memory device 130 may be implemented as one or more integrated circuits located on one or more dies. In another embodiment, the memory sub-system 110 may be implemented as a System-on-Chip, which, in addition to the memory device 130 and memory sub-system controller 115 of FIG. 1, may include one or more processing cores and one or more input/output (I/O) interfaces.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In some embodiments, the interface between the host system 120 and the memory sub-system 110 can implement one or more alternate protocols supported by another interface standard. For example, the interface can implement one or more alternate protocols supported by PCIe (e.g., non-PCIe protocols). In some embodiments, the interface can be represented by the compute express link (CXL) interface or any communication link that allows cache line granularity updates and shares coherency control with the processor 117.

The memory sub-system 110 can include a dynamic block allocation component 113. Although not shown in FIG. 1 so as to not obfuscate the drawings, the dynamic block allocation component 113 can include various circuitry to facilitate movement of data blocks from a user data area to a file system area of the memory device. In some embodiments, the dynamic block allocation component 113 can include special purpose circuitry in the form of an ASIC, FPGA, state machine, and/or other logic circuitry that can allow the dynamic block allocation component 113 to orchestrate and/or perform operations to selectively trigger data mover for the memory device 130 and/or the memory device 140 based on logic inside a controller of the memory device tracking addresses and determining to push data into cache controller including prefetch logic and sending messages to the memory device 130 to a monitoring engine in the memory device 130 causing the memory device 130 to move the data.

In some embodiments, the memory sub-system controller 115 includes at least a portion of the dynamic block allocation component 113. For example, the memory sub-system controller 115 can include a processor 117 (processing device) configured to execute instructions stored in local memory 119 for performing the operations described herein. In some embodiments, the dynamic block allocation component 113 is part of the host system 110, an application, or an operating system.

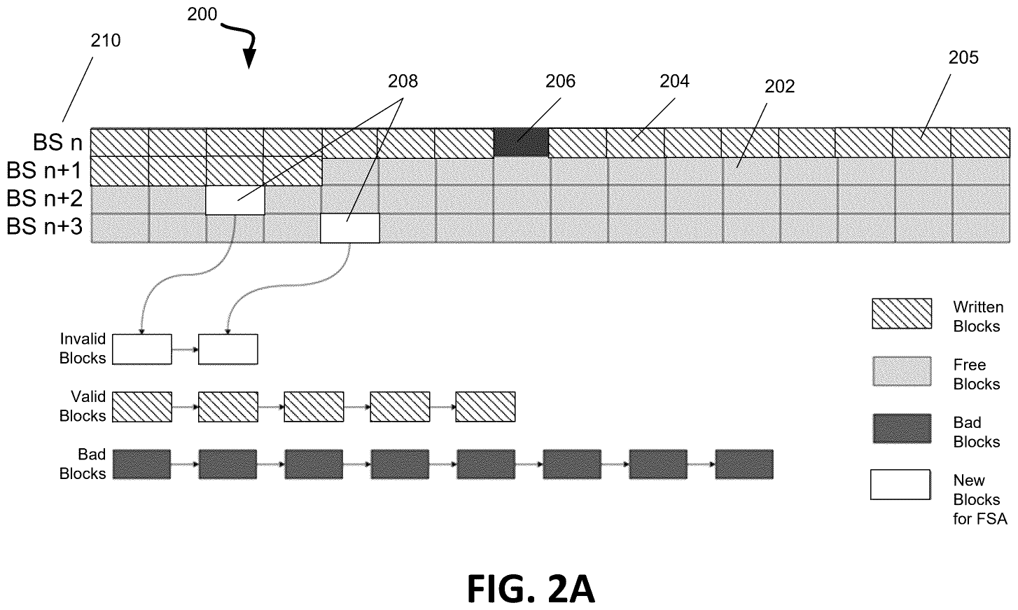

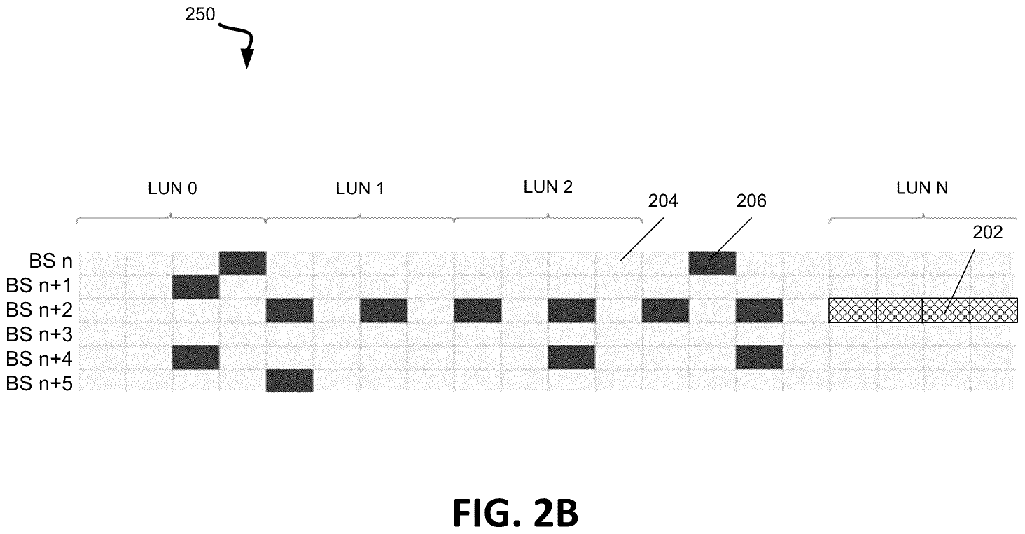

In a non-limiting example, an apparatus (e.g., the computing system 100) can include a memory sub-system dynamic block allocation component 113. The memory sub-system dynamic block allocation component 113 can be resident on the memory sub-system 110. As used herein, the term “resident on” refers to something that is physically located on a particular component. For example, the memory sub-system dynamic block allocation component 113 being “resident on” the memory sub-system 110 refers to a condition in which the hardware circuitry that comprises the memory sub-system dynamic block allocation component 113 is physically located on the memory sub-system 110. The term “resident on” can be used interchangeably with other terms such as “deployed on” or “located on,” herein. The operations performed by the dynamic block allocation component 113 will now be described in further detail in FIGS. 2A and 2B.

FIG. 2A illustrates a logical unit (LUN) level view of a file system area 200 for dynamic block allocation in accordance with some embodiments of the present disclosure. The file system area 200 may include two or more block stripes 210, and each block stipe may include one or more data blocks 205. The memory sub-system dynamic block allocation component 113 can be configured to mark, during the creation of a file system area, data blocks reserved for the file system area as “reserved blocks” 208 and bypasses FTL management, and those reserved bocks 208 are not used to store host data. The dynamic block allocation component 113 tracks information about the blocks in the FSA in the file system root record (FRR). A FRR is a root file of the file system area that maintains the file management information. FSA is responsible for its own block management and uses physical NAND addresses for reading and writing files.

The memory sub-system 110 may include two or more channels (e.g., 8 channels), and each channel may include a logical unit (LUN), which may include two or more planes (e.g., 4 planes). The FSA of the memory sub-system 110 may include two or more partitions. One partition may be assigned to boot area and another partition may be assigned to an extended area. Data blocks for boot partition are allocated from the first LUN of each channel. This partition may be used for storing system boot related files including bootloader FRR and other related files. The rest of the files saved in FSA are considered as extended partition. NAND blocks allocated for this partition can use the LUNs other than first LUN of the channel if available.

In some implementations, the dynamic block allocation component 113 maintains three or more pools in each partition to manage FSA blocks, which include an invalid block pool 202, a valid block pool 204, and a bad block pool 206. Each pool may include one or more data blocks 205 that may be used by the FSA 200. The invalid block pool 202 includes one or more data blocks that may be readily used by the FSA 200. The valid block pool 204 includes data blocks that are currently in use by the FSA. The dynamic block allocation component 113 brings a block from the invalid block pool when there are not enough valid blocks. The bad block pool 206 contains data blocks that when FSA blocks encounter a failure (e.g., UECC, erase failure, etc.) the dynamic block allocation component 113 moves a block from valid pool 204 and puts them into a bad block pool 206. Accordingly, the FSA maintains six block pools in total, three block pools for boot partition and three block pools for extended partition.

In some implementations, the memory sub-system enters read only mode based on occurrence of certain internal events that host has no knowledge of. Some examples of the events which may cause memory sub-system to enter read only mode include the number of free user blocks available for host write falls below a certain threshold. In another example, the number of bad blocks 206 of FSA is greater than a certain threshold which means FSA cannot perform new writes. When memory sub-system enters read only mode, any write related operation will be stopped, which includes host writes, folding writes, and smart logs also cannot be persisted to NAND. Accordingly, over-provisioning (OP) is an important feature offered by memory sub-systems manufacturers which improves performance by providing spare drive capacity which dynamic block allocation component 113 can use to optimize its internal processes. Even if the memory sub-system is fully filled with host data, there will still be free blocks in the drive due to OP.

Conventionally, FSA blocks are allocated statically at one time, with the total number of blocks and the location of the blocks all fixed across the drive life cycle. However, when FSA encounters UECC/program failure/erase failure, the number of FSA good blocks may decrease, or the NAND die may even fail and as a result all the blocks including FSA blocks in the failed die can be marked as bad blocks, which makes the number of FSA blocks decrease dramatically.

In such conditions, the FSA needs to add victim blocks to bad blocks list, which may decrease the number of FSA valid blocks 204. If the number of bad blocks 206 reaches a defined threshold, the FSA needs to enter read only mode. As the FSA is no longer fully functional, drive internal log also cannot be persisted to NAND, as well as some other memory sub-system important files (e.g., file for bad blocks list). Accordingly, the entire drive enters read only mode to avoid FSA write.

As consequence of FSA read only mode, media scan is also impacted which hurts data integrity of host data existing in the drive. This can be more serious meaning the read only cannot even guarantee previously acknowledged host data can be correctly retrieved by the host because media scan relies on garbage collection to refresh the data around blocks. As garbage collection is stopped due to read only mode, media scan also needs be stopped which means that there is no task to scan the data with predefined interval and refresh the data in time to meet the data retention requirements. This may consequently lead to host data loss.

Accordingly, in some embodiments an advanced FSA design for memory sub-system which avoids memory sub-system read only mode even if there is NAND degradation is provided. Embodiments disclosed allow FSA to allocate blocks from user data area when the number of FSA free blocks is less than a defined threshold during life cycle, and ensures that FSA does not enter read only mode. This can be handled in drive runtime stage, which means in user space there can be written blocks, free blocks, and garbage blocks.

In some implementations, the dynamic block allocation component 113 receives a write request from the host, and the dynamic block allocation component 113 checks to see if there are enough free blocks in the FSA, and if there are not enough blocks in the FSA, then dynamic allocation of blocks to FSA is triggered. The dynamic block allocation component 113 first checks the retired blocks from the user area. If there are not sufficient blocks in the retired blocks, then the dynamic block allocation component 113 looks in the garbage block area where a block stripe may be fully written or partially written, and does not need to be erased immediately. If there are not sufficient blocks in the garbage block area, then the dynamic block allocation component 113 checks the free block area. In this area block stripe is erased and may be allocated to a cursor for writing. To reduce the impact to host data, the dynamic block allocation component 113 allocates blocks from garbage block stripe area at first. If there's no block in the garbage area, then the dynamic block allocation component 113 allocates blocks from the free block area. In order to make sure there is no coherency issue between the FSA and the user area when allocating blocks from the same pool, the memory sub-system may lock host cursor and FTL cursor during dynamic FSA block allocation so that only FSA can allocate blocks during this period.

FIG. 2B illustrates a logical unit (LUN) level view of a file system area 250 in accordance with some embodiments of the present disclosure. In some implementations, the block stripe is retired if the number of blocks in the block stripe are greater than a defined threshold. The dynamic block allocation component 113 in this case checks the retired blocks to see if there are any blocks that can be allocated to the FSA, and if there are blocks available (e.g., in LUN N), then one or more of those blocks are allocated to FSA. This process does not result in any performance degradation because the retired block stripe is not used by the host and not involved in host input/output operations. After a block stripe is selected, a suitable logical unit (LUN) with the least number of bad blocks is selected. The dynamic block allocation component 113 determines the number of bad blocks in each LUN, selects the LUN with the least number of bad blocks, and allocates one or more data blocks from that LUN to the FSA.

In some implementations, if there are no blocks in the retired block stripes, then the dynamic block allocation component 113 checks the garbage block stripes, and selects a LUN with the least number of bad blocks. The dynamic block allocation component 113 then allocates one or more blocks from the LUN having the least number of bad blocks. If two or more block stripes have the same number of bad blocks, then the dynamic block allocation component 113 may randomly pick one or more blocks from a block stripe and update the block count in the FRR.

Another embodiment is a method for managing bad blocks after selection for the FSA. Since FSA block allocation may occur during host input/output operations, the block selection overhead may impact host write command latency. Accordingly, one embodiment is a method for maintaining a bad block table (e.g., a bitmap) which is regularly updated with information for each block stripe and each die after every block allocation. The status of each data block can be identified using one or more bits of data or a “status identifier.” For example, a 0x00 may reflect the block is a good block, a 0x01 may reflect a memory sub-system manufacturing burn in (BI) retired block, a 0x02 may reflect a field grown retired block, a 0x03 may reflect a die manufacturing one-time programmable retired block, a 0x04 may reflect a reserved block for FSA, so on and so forth. This table may be updated after allocation such that the dynamic block allocation component 113 only has to refer to this table to quickly find blocks within a block stripe and within a LUN that can be allocated to the FSA (e.g., blocks with a 0x00 status). As a result of this method of keep track of the data blocks using a block table, the overhead for block selection is significantly reduced from several megabytes to a few kilobytes.

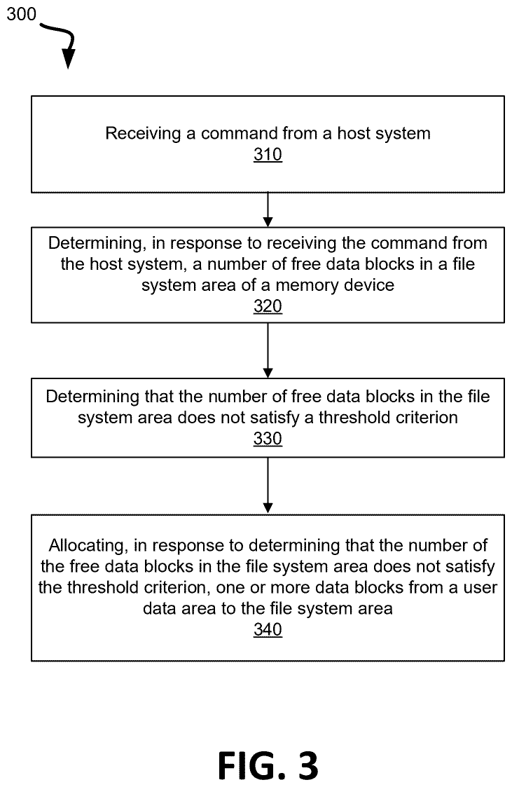

FIG. 3 is a flow diagram of an example method 300 for allocating data blocks from a user data area to a file system area, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by a delta logging component in the memory sub-system controller 115 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic receives a command (e.g., write request) from the host system 120. At operation 320, the processing logic checks to see if there are enough free blocks in the FSA, and if there are not enough blocks in the FSA, then dynamic allocation of blocks to FSA is triggered. For example, the processing logic may determine the number of free blocks in the FSA of the memory sub-system, and if the number of free blocks does not satisfy a threshold criterion (e.g., if the number of free blocks is less than a defined threshold), then the dynamic allocation of data blocks to FSA may be triggered. At operation 330, if the number of data blocks in the FSA does not satisfy the threshold criterion, then then processing logic may allocate one or more data blocks from a user data area to the FSA. For example, the processing logic first checks the retired blocks from the user area. If there are not sufficient blocks in the retired blocks, then the processing logic looks in the garbage block area where a block stripe may be fully written or partially written, and does not need to be erased immediately. If there are not sufficient blocks in the garbage block area, then the processing logic checks the free block area. In this area block stripe is erased and may be allocated to a cursor for writing. To reduce the impact to host data, the processing logic allocates blocks from garbage block stripe area at first. If there's no block in the garbage area, then the processing logic allocates blocks from the free block area, at operation 340. In order to make sure there is no coherency issue between the FSA and the user area when allocating blocks from the same pool, the memory sub-system may lock host cursor and FTL cursor during dynamic FSA block allocation so that only FSA can allocate blocks during this period.

In some implementations, the block stripe is retired if the number of blocks in the block stripe are greater than a defined threshold. The processing logic in this case checks the retired blocks to see if there are any blocks that can be allocated to the FSA, and if there are blocks available (e.g., in LUN N), then one or more of those blocks are allocated to FSA. This process does not result in any performance degradation because the retired block stripe is not used by the host and not involved in host input/output operations. After a block stripe is selected, a suitable logical unit (LUN) with the least number of bad blocks is selected. The processing logic determines the number of bad blocks in each LUN, selects the LUN with the least number of bad blocks, and allocates one or more data blocks from that LUN to the FSA.

In some implementations, if there are no blocks in the retired block stripes, then the processing logic checks the garbage block stripes, and selects a LUN with the least number of bad blocks. The processing logic then allocates one or more blocks from the LUN having the least number of bad blocks. If two or more block stripes have the same number of bad blocks, then the processing logic may randomly pick one or more blocks from a block stripe and update the block count in the FRR.

Another embodiment is a method for managing bad blocks after selection for the FSA. Since FSA block allocation may occur during host input/output operations, the block selection overhead may impact host write command latency. Accordingly, one embodiment is a method for maintaining a bad block table (e.g., a bitmap) which is regularly updated with information for each block stripe and each die after every block allocation. The status of each data block can be identified using one or more bits of data or a “status identifier.” For example, a 0x00 may reflect the block is a good block, a 0x01 may reflect a memory sub-system manufacturing burn in (BI) retired block, a 0x02 may reflect a field grown retired block, a 0x03 may reflect a die manufacturing one-time programmable retired block, a 0x04 may reflect a reserved block for FSA, so on and so forth. This table may be updated after allocation such that the processing logic only has to refer to this table to quickly find blocks within a block stripe and within a LUN that can be allocated to the FSA (e.g., blocks with a 0x00 status). As a result of this method of keep track of the data blocks using a block table, the overhead for block selection is significantly reduced from several megabytes to a few kilobytes.

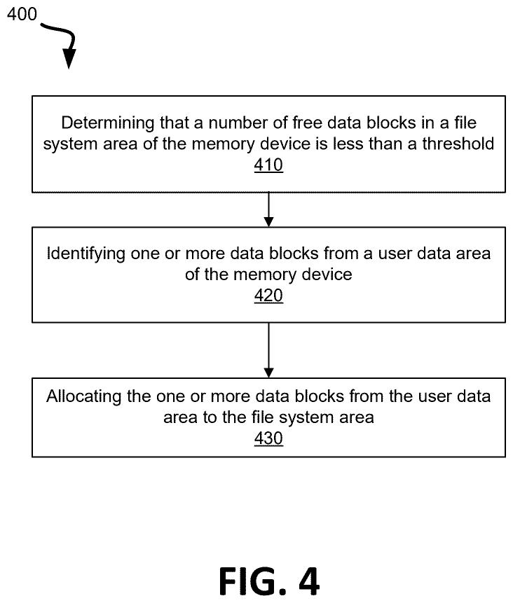

FIG. 4 is a flow diagram of an example method 400 for allocating data blocks from a user data area to a file system area of a memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by a delta logging component in the memory sub-system controller 115 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic determines that a number of free data blocks in a file system area of the memory device is less than a defined threshold. At operation 420, the processing logic identifies one or more data blocks from a user data area of the memory device, and allocates the one or more data blocks from the user data area to the file system area, at operation 430. Allocating the one or more data blocks may involve selecting a first data block from an available data blocks in a first pool in the user data area. Allocating the one or more data blocks may further involve determining the available data blocks in the first pool is less than a first threshold, and selecting a second data block from a plurality of available data blocks in a second pool in the user data area, the processing logic first checks the retired blocks from the user area. If there are not sufficient blocks in the retired blocks, then the processing logic looks in the garbage block area where a block stripe may be fully written or partially written, and does not need to be erased immediately. If there are not sufficient blocks in the garbage block area, then the processing logic checks the free block area. In this area block stripe is erased and may be allocated to a cursor for writing. To reduce the impact to host data, the processing logic allocates blocks from garbage block stripe area at first. If there's no block in the garbage area, then the processing logic allocates blocks from the free block area, at block 340. In order to make sure there is no coherency issue between the FSA and the user area when allocating blocks from the same pool, the memory sub-system may lock host cursor and FTL cursor during dynamic FSA block allocation so that only FSA can allocate blocks during this period.

In some implementations, the block stripe is retired if the number of blocks in the block stripe are greater than a defined threshold. The processing logic in this case checks the retired blocks to see if there are any blocks that can be allocated to the FSA, and if there are blocks available (e.g., in LUN N), then one or more of those blocks are allocated to FSA. This process does not result in any performance degradation because the retired block stripe is not used by the host and not involved in host input/output operations. After a block stripe is selected, a suitable logical unit (LUN) with the least number of bad blocks is selected. The processing logic determines the number of bad blocks in each LUN, selects the LUN with the least number of bad blocks, and allocates one or more data blocks from that LUN to the FSA.

In some implementations, if there are no blocks in the retired block stripes, then the processing logic checks the garbage block stripes, and selects a LUN with the least number of bad blocks. The processing logic then allocates one or more blocks from the LUN having the least number of bad blocks. If two or more block stripes have the same number of bad blocks, then the processing logic may randomly pick one or more blocks from a block stripe and update the block count in the FRR.

Another embodiment is a method for managing bad blocks after selection for the FSA. Since FSA block allocation may occur during host input/output operations, the block selection overhead may impact host write command latency. Accordingly, one embodiment is a method for maintaining a bad block table (e.g., a bitmap) which is regularly updated with information for each block stripe and each die after every block allocation. The status of each data block can be identified using one or more bits of data or a “status identifier.” For example, a 0x00 may reflect the block is a good block, a 0x01 may reflect a memory sub-system manufacturing burn in (BI) retired block, a 0x02 may reflect a field grown retired block, a 0x03 may reflect a die manufacturing one-time programmable retired block, a 0x04 may reflect a reserved block for FSA, so on and so forth. This table may be updated after allocation such that the processing logic only has to refer to this table to quickly find blocks within a block stripe and within a LUN that can be allocated to the FSA (e.g., blocks with a 0x00 status). As a result of this method of keep track of the data blocks using a block table, the overhead for block selection is significantly reduced from several megabytes to a few kilobytes. The status identifier may reflect a good data block, a manufacturing burn in retired data block, a field grown retired data block, a one-time programmable retired data block, or a file system area reserved data block.

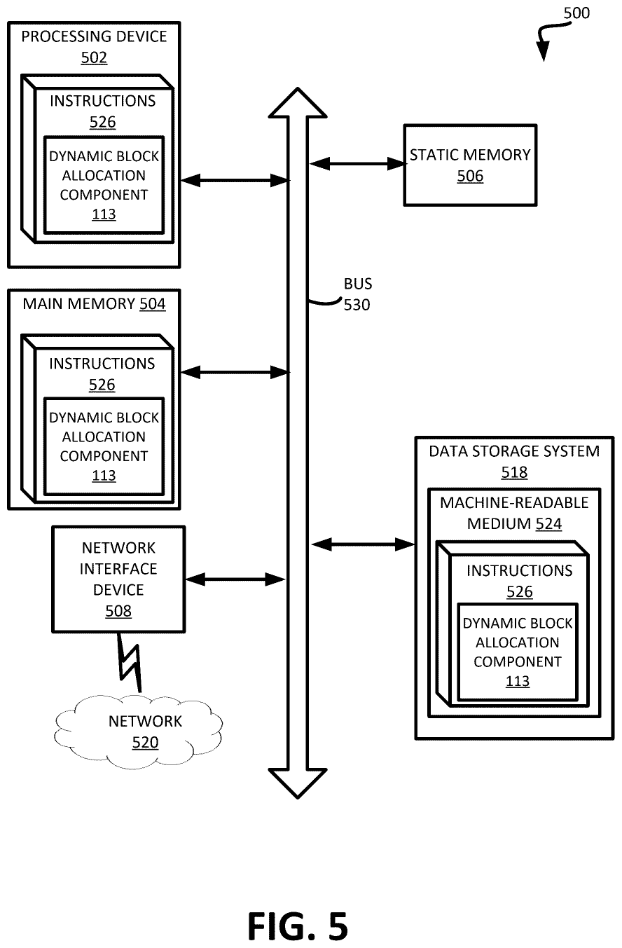

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the dynamic block allocation component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a dynamic block allocation component (e.g., the dynamic block allocation component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving a command from a host system;
determining, in response to receiving the command from the host system, a number of free data blocks in a file system area of a memory device;
determining that the number of free data blocks in the file system area does not satisfy a threshold criterion; and
allocating, in response to determining that the number of the free data blocks in the file system area does not satisfy the threshold criterion, one or more data blocks from a user data area to the file system area.

2. The method of claim 1, wherein allocating the one or more data blocks comprises:
selecting a first data block from a plurality of available data blocks in a first pool in the user data area;
determining that a number of the plurality of available data blocks in the first pool is less than a first threshold; and
selecting a second data block from a plurality of available data blocks in a second pool in the user data area.

3. The method of claim 2, wherein allocating the one or more data blocks further comprises:
determining that the plurality of available data blocks in the second pool is less than a second threshold; and
selecting a third data block from a plurality of available data blocks in a third pool in the user data area.

4. The method of claim 2, wherein selecting the first data block from the plurality of available data blocks in the first pool comprises:
determining a number of bad data blocks in a plurality of data block stripes in the first pool;
identifying a data block stripe from the plurality of data block stripes with a least number of bad data blocks; and
allocating one or more data blocks from the data block stripe to the file system area.

5. The method of claim 2, wherein allocating the one or more data blocks further comprises:
marking the one or more data blocks as a reserved bad data block and adding the one or more data blocks to a file system area data block list.

6. The method of claim 1, further comprising:
generating a lookup table mapping each data block to a corresponding status identifier, the status identifier identifying a current status of the corresponding data block; and
selecting, based on a selection criteria, the data block from the lookup table.

7. The method of claim 6, wherein the status identifier comprises at least one of a good data block, a manufacturing burn in retired data block, a field grown retired data block, a one-time programmable retired data block, or a file system area reserved data block.

8. The method of claim 1, further comprising:
suspending a host operation prior to selecting the one or more data blocks.

9. A system comprising:
a memory device; and
a processing device, operatively coupled to the memory device, the processing device to perform operations comprising:
determining that a number of free data blocks in a file system area of the memory device is less than a threshold;
identifying one or more data blocks from a user data area of the memory device; and
allocating the one or more data blocks from the user data area to the file system area.

10. The system of claim 9, wherein the allocating the one or more data blocks further comprises:
selecting a first data block from a plurality of available data blocks in a first pool in the user data area;
determining the plurality of available data blocks in the first pool is less than a first threshold; and
selecting a second data block from a plurality of available data blocks in a second pool in the user data area.

11. The system of claim 10, wherein the operations further comprise:
determining that the plurality of available data blocks in the second pool is less than a second threshold; and
identifying a third data block from a plurality of available data blocks in a third pool in the user data area.

12. The system of claim 10, wherein identifying the first data block from the plurality of available data blocks in the first pool further comprises:
determining the number of bad data blocks in a plurality of data block stripes in the first pool;
identifying a data block stripe from the plurality of data block stripes with a least number of bad data blocks; and
allocating one or more data blocks from the data block stripe to the file system area.

13. The system of claim 12, wherein allocating further comprises marking the one or more data blocks as a reserved bad data block and adding the one or more data blocks to a file system area data block list.

14. The system of claim 9, wherein the operations further comprise:
generating a lookup table mapping each data block to a corresponding status identifier, the status identifier identifying a current status of the corresponding data block; and
selecting, based on a selection criteria, the data block from the lookup table.

15. The system of claim 14, wherein the status identifier comprises at least one of a good data block, a manufacturing burn in retired data block, a field grown retired data block, a one-time programmable retired data block, or a file system area reserved data block.

16. A non-transitory computer-readable storage medium comprising instructions that, when executed by a processing device, cause the processing device to perform operations comprising:
receiving a command from a host system;
determining, in response to receiving the command from the host system, a number of free data blocks in a file system area of a memory device;
determining that the number of free data blocks in the file system area does not satisfy a threshold criterion; and
allocating, in response to determining the number of the free data blocks in the file system area does not satisfy the threshold criterion, one or more data blocks from a user data area to the file system area.

17. The non-transitory computer-readable storage medium of claim 16, wherein the allocating the one or more data blocks further comprises:
selecting a first data block from a plurality of available data blocks in a first pool in the user data area;
determining that the plurality of available data blocks in the first pool is less than a first threshold; and
selecting a second data block from a plurality of available data blocks in a second pool in the user data area.

18. The non-transitory computer-readable storage medium of claim 17, further comprising:
determining that the plurality of available data blocks in the second pool is less than a second threshold; and
selecting a third data block from a plurality of available data blocks in a third pool in the user data area.

19. The non-transitory computer-readable storage medium of claim 17, wherein selecting the first data block from the plurality of available data blocks in the first pool further comprises:
determining the number of bad data blocks in a plurality of data block stripes in the first pool;
identifying a data block stripe from the plurality of data block stripes with a least number of bad data blocks; and
allocating one or more data blocks from the data block stripe to the file system area.

20. The non-transitory computer-readable storage medium of claim 19, wherein allocating the one or more data blocks further comprises marking the one or more data blocks as a reserved bad data block and adding the one or more data blocks to a file system area data block list.
